(19) United States
(12) Patent Application Publication
(10) Pub. No.: US 2015/0124454 A1
(43) Pub. Date: May 7, 2015

(54) LED RETROFIT LAMP

(71) Applicant: DFM IP LIMITED, Birkirkara (MT)

(72) Inventor: Jürgen Honold, Birkirkara (MT)

(21) Appl. No.: 14/394,980

(22) PCT Filed: Apr. 12, 2013
(86) PCT No.: PCT/DE2013/200009

§ 371 Date: Jan. 22, 2015

(30) Foreign Application Priority Data
Apr. 18, 2012 (DE) 10 2012 007 630.4

(51) Int. Cl. F21K 99/00; F21V 23/00; F21V 3/00; F21V 29/70

(52) U.S. Cl. CPC F21K 9/135; F21V 29/70; F21V 23/005; F21K 9/56; F21V 3/00
USPC 362/293; 362/294

(57) ABSTRACT

A retrofit LED lamp comprising at least LED light-emitting means, a lampholder, a heat sink and a diffuser envelope, wherein a high-voltage LED module is used as LED light-emitting means, voltage is supplied to said high-voltage LED module via an integrated circuit in the form of a microchip, and this integrated circuit of the high-voltage LED module is driven directly by the mains voltage available, wherein the heat dissipation of the high-voltage LED module takes place by means of a heat sink consisting of a compound plastic, which is thermally conductive via inclusions in the plastic but electrically insulating, wherein a core with a high degree of thermal conductivity in the heat sink as heat-spreading medium introduces the heat output by the high-voltage LED module uniformly into the heat sink.

The invention relates to a retrofit LED lamp in accordance with the preamble of claim 1.

The use of LED light-emitting means plays an outstanding role in the new development of lamps as light sources owing to their technical advantages in comparison with conventional light-emitting means in respect of, for example, energy consumption and life. Efforts at the moment are in this case aimed at also replacing light-emitting means in everyday usage which are used as standard in large numbers with LED applications. In particular, attempts are being made to implement the traditional incandescent bulb configuration as so-called retrofit lamps by means of LED technology as well and thus, inter alia, to make a contribution to climate protection as well.

Until now, no success has been made in this case in providing a solution to an incandescent bulb configuration on an LED basis which is also comparable economically to conventional incandescent bulbs or at least is within a tolerable range in terms of price for the end user.

The object of the present invention can therefore be considered that of designing an economically sensible alternative to previous incandescent bulbs on the basis of LED technology which implements the advantages of LED technology in an incandescent bulb substitute which is suitable for everyday use.

The term retrofit lamp in this context means a light-emitting means which can be used with conventional lampholders in already existing lamps. The prior art, as reflected also in the publication DE 10 2009 035 515 of a light-emitting device, for example, envisages in this case that this LED light-emitting means is equipped with a driver for converting the mains voltage into lower voltages of approximately 10-25 volts. The location of the arrangement of such a driver is generally in the lampholder itself.

Furthermore, LED lamps in principle require heat sinks in order to dissipate the heat generated at points by the LEDs since overheating of the LEDs has a negative influence on the function and life thereof. The LEDs are generally arranged on a mount, which is positioned on this heat sink, wherein it is relevant that insulation with respect to this generally thermally conductive and electrically conductive heat sink takes place in order to safely avoid the user being subjected to any electric shocks. The disclosure of DE 10 2009 035 515 in this case relates, against this background, to the advantageous arrangement of an LED mount on a heat sink.

The subject matter of the present application, however, goes beyond these known designs of retrofit LED lamps by proposing a solution which enables simple and inexpensive manufacture and additionally simplifies the design of the retrofit LED lamp. In this case, various technical approaches to solutions are combined in a lamp body which is intended to enable inexpensive production of a retrofit LED lamp.

A central feature of the invention in this case consists in that, in contrast to the prior art, a retrofit LED lamp with a high-voltage LED module is intended to be realized. This high-voltage LED module is intended to be able to be actuated via a direct connection to the mains voltage, in conjunction with an integrated circuit (IC), which is arranged directly on the printed circuit board of the high-voltage LED module as well. In this way, a driver for converting the voltage for the retrofit LED lamp according to the invention can be dispensed with completely.

This firstly has advantages in respect of the production costs of the lamp, but secondly also in respect of the life since this is now no longer based on the driver but exclusively on the LEDs which have a longer life. A further positive aspect can be a space saving which arises depending on the embodiment of the lamp body. Further positive aspects of this design solution are a suppression of the frequently occurring 100 Hz flicker and good dimmability of the lamp, which is achieved owing to the microchip used as integrated circuit.

The lack of a driver as voltage converter in the retrofit LED lamp according to the invention also enables further-reaching inventive improvements in the lamp design in the field of heat dissipation.

In this case, the essential advantage of the retrofit LED lamp according to the invention consists in that the design of said retrofit LED lamp can be based markedly more closely on the conventional design of an incandescent lamp owing to the lack of a driver as voltage converter. This is achieved by the innovative use of a plastic compound material which is used as heat sink.

In this case, it is central that this plastic material combines electrically insulating properties with thermal conductivity. That is to say that this plastic can be arranged externally as heat sink between the lampholder and the light-emitting plane, wherein a central design feature consists in that the heat to be dissipated from the LED printed circuit board is introduced, via a core with high thermal conductivity, for example consisting of metal, uniformly into the plastic compound heat sink casing which has much lower thermal conductivity. One advantage that results is that a heat-emitting LED arrangement can be positioned directly on the heat sink since, in contrast to the metal heat sinks, in this case no additional insulation measures such as, for example, insulating films or ceramic platelets are required.

Therefore, a central improvement consists in that the heat to be dissipated is distributed, via this thermal bridge with high thermal conductivity in the core of the heat sink, uniformly onto the inner surface of the heat sink in such a way that the lower thermal conductivity of the plastic compound does not result in a buildup of heat in the LED light-emitting means either. Sufficient heat is removed from the LEDs in this way, but at the same time the proportion of thermally conductive fillers in the compound can be reduced to a necessary degree as a result of the spread of heat, which represents an essential factor for reducing costs. In addition, the material quality of the compound is improved with the reduction in the fillers since said fillers are very brittle and fragile in the case of a high content of fillers, which entails problems during the manufacturing process.

In this case, various designs of the retrofit LED lamp are provided. The metal core can thus be formed in accordance with the invention from a metal lampholder, which, in contrast to the prior art, at the same time forms the metal core for the heat sink. This can be constructed continuously as a type of extension of a lampholder, which is therefore continued, in the form of a tube, above the lampholder up to the plane of the LED printed circuit board and therefore forms a continuous hollow metal sleeve.

As an alternative to this, this metal sleeve can be connected to the likewise metal lampholder of the lamp only retrospectively by virtue of said lampholder being flanged or crimped onto the metal heat sinks. In this case, it is efficient in terms of process technology to insert a corresponding sleeve body into the tool for producing the plastic injection molding of the plastic compound heat sink and therefore to produce the composite between the metal core in the form of the extended lampholder and the plastic heat sink.

In this case, an essential aspect of the invention consists in that, in this way, the supply of voltage to the light-emitting means can take place directly in a conventional manner via the lampholder, so as to avoid the driver, since said lampholder is electrically conductive but is insulated by the plastic compound heat sink and therefore the risk of the user being subjected to an electric shock is safely avoided. At the same time, this insulating heat sink nevertheless performs the function of heat dissipation and therefore has a dual function, which makes it possible for the heat dissipation to take place only via the metal core, which has high conductivity, which then in turn dissipates its heat very uniformly and over a large area into the compound plastic surrounding it.

It has proven to be particularly advantageous for the plastic compound material for the thermal conductivity of said plastic compound material to be adjusted, as desired, by inclusions of boron nitride. However, other substances as inclusion materials are also possible, for example copper, aluminum, or graphite inclusions which are suitable for adjusting the thermal conductivity in the plastic compound to a desired value.

In a further advantageous solution, it is provided in the production method for the lamp body for the step of soldering the LEDs onto the printed circuit board to also be included in the injection-molding operation for the heat sink. In this way, it is possible to achieve a situation whereby the heat required for the soldering step for the LEDs is introduced into the printed circuit board via the injection-molding operation of the plastic body.

In principle, provision is made here for the printed circuit board bearing the LEDs to be covered by a dome-like or bulb-shaped diffuser, which ensures uniform light emission of the LEDs emitting in punctiform fashion. This is required for achieving a uniform light and for avoiding glare when looking at the retrofit LED lamp.

A particularly advantageous design in this case envisages a so-called “remote phosphor” dome part of this diffuser, i.e. provision is made in terms of the design, for example, for a first body provided with a phosphor coating to be arranged over the LED printed circuit board, wherein this first envelope body is excited by the light emission of the LEDs and therefore a uniform light emission of this phosphorescent coating is achieved. The actual diffuser is then arranged over this remote phosphor envelope, which diffuser once again ensures improved light distribution and changes the hue of the emitted light, if appropriate.

In a further particularly advantageous embodiment of the invention, it is provided that the actual diffuser envelope itself is provided with a phosphor coating on its inner surface and therefore this advantageous light distribution and emission can likewise be achieved without a second remote phosphor envelope. In this case, it is provided that the diffuser is provided with a phosphor coating on the inside. In addition to the light emission, uniform heat dissipation is also achieved via the glass envelope, for example, as a result.

The invention will be explained in more detail below with reference to drawings, in which

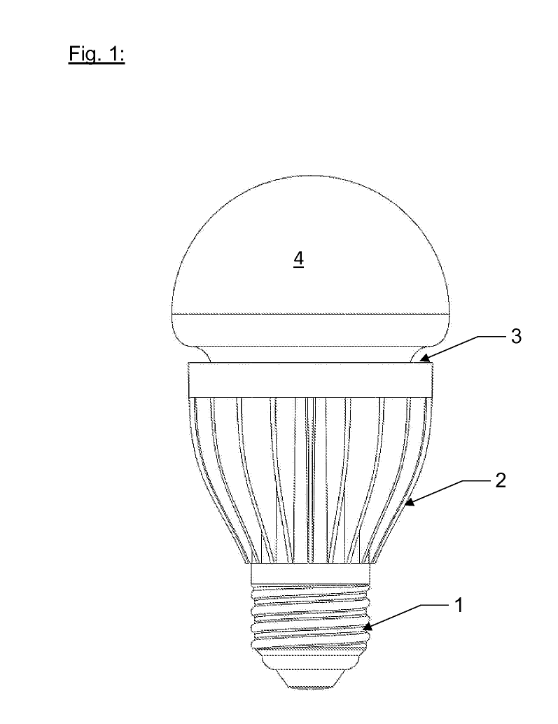

FIG. 1 shows a lateral view of the retrofit LED lamp according to the invention comprising lateral identifiable cooling ribs of the compound plastic heat sink,

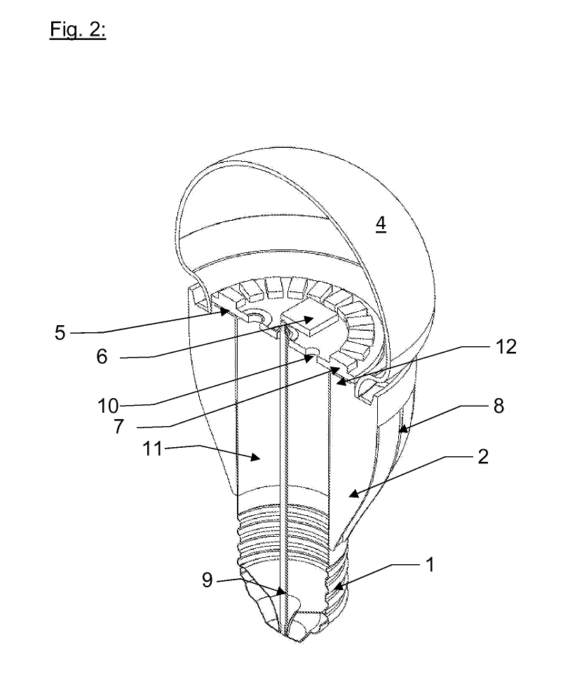

FIG. 2 shows a section through the retrofit LED lamp, in a perspective illustration, with the LED printed circuit board and microchip inserted and the diffuser positioned,

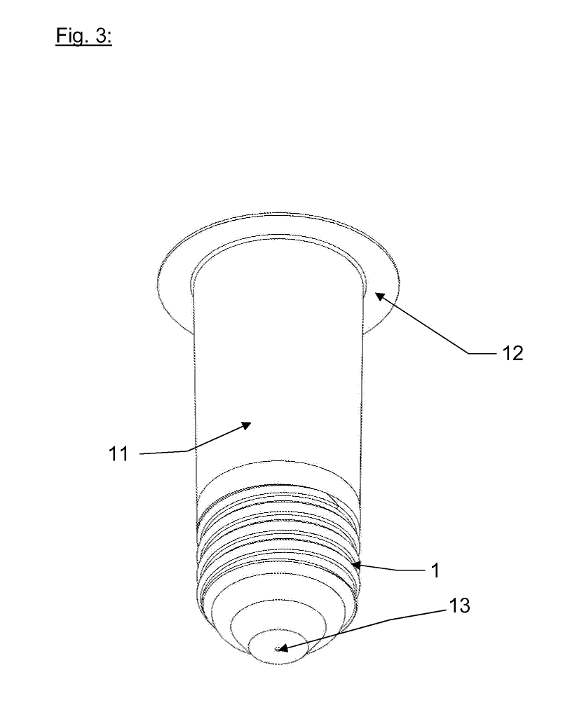

FIG. 3 shows the metal core as an extension of the lampholder for spreading the heat over the heat sink,

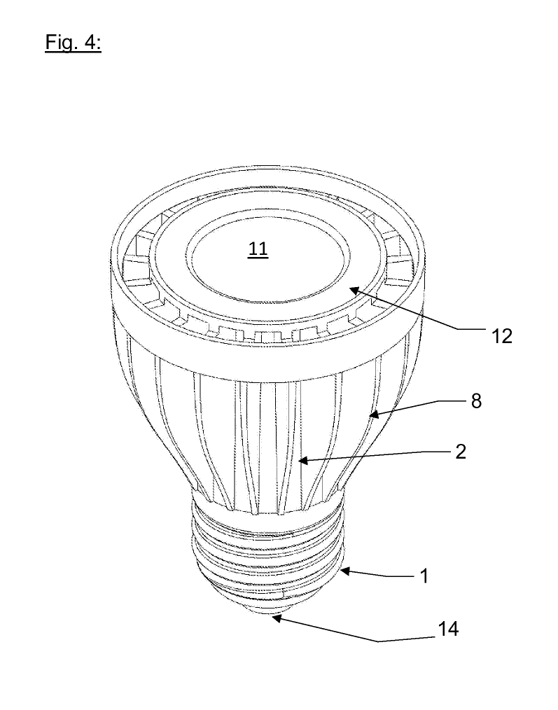

FIG. 4 shows a perspective view of the heat sink with internal metal core and terminating lampholder, and

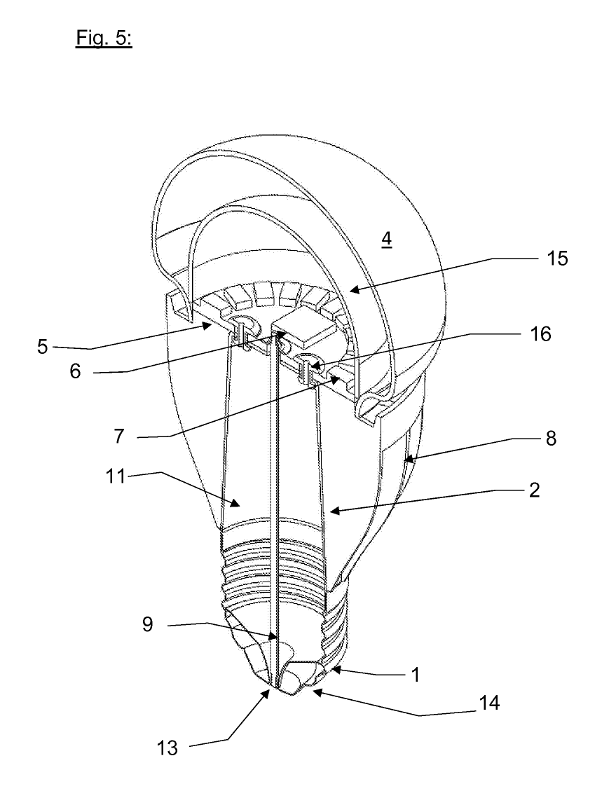

FIG. 5 shows a perspective section through the retrofit LED lamp according to the invention with an additional remote phosphor envelope.

The basic design of the entire retrofit lamp is shown in FIG. 1. Said basic design comprises a conventional lampholder 1, in this case with the format E27, over which the heat sink 2 passes as far as the plane 3 of the LED printed circuit board 5. This is closed off by the bulb-shaped diffuser 4 for controlling the LED emission.

FIG. 2 shows a perspective section through the lamp body, in which, as already described in the lateral view, the heat sink 2 extends up to plane 3 of the LED printed circuit board 5, starting from the lampholder 1. In this case, however, it becomes clear that the lampholder 1 is not merely fastened at the lower end of the heat sink 2, but that it extends into the metal, sleeve-shaped, heat-transfer core 11 as far as below the LED printed circuit board 5, or this is a structural unit.

The present design comprises a continuous sleeve-shaped metal core 11, which merges with a flange 12 which branches off at right angles at the upper end of said metal core which is arranged below the LED printed circuit board, and the LED printed circuit board rests on said flange. The heat sink 2, which has cooling ribs 8 distributed uniformly over its circumference, is in this case arranged so as to bear over the full area on the sleeve-shaped core 11, or the heat sink 2 consisting of compound plastic is injection-molded directly onto the metal core 11. By virtue of this design, a uniform input of heat directly into the compound plastic heat sink over the entire area of the core 11 above the thread 1 results.

As can be seen in section, this design does not have a driver as electronic component, but merely a microchip 6 as integrated circuit on the LED printed circuit board 5. A multiplicity of LEDs 7 are arranged next to one another at the rim on the LED printed circuit board 5 around this microchip, wherein the distribution of voltage among these LEDs 7 takes place via the microchip 6.

In addition, the LED printed circuit board 5 has 3 central bores 10, of which two can be used for passing through fastening means, for example for riveting the LED printed circuit board 5 onto the metal core 11. The central bore arranged in the center of the LED printed circuit board 5 is used for passing through a phase 9 for supplying voltage to the microchip 6. The second phase in this design takes place directly over the metal core 11 since this is insulated by the heat sink 2 and therefore safety is maintained when working with the lamp.

The diffuser 4 is positioned directly onto the heat sink 2 above the LED light-emitting plane 3. Said diffuser therefore spans the LED light-emitting plane 3 in the form of a bulb and results in a uniform emission of light energy.

FIG. 3 shows the core 11 according to the invention as metal core of the heat sink 2, which has not yet been applied to the core 11 in this illustration. It can be seen here that a sleeve-shaped extension of the thread 1 is present as support body for the compound plastic heat sink 2. This workpiece of the core 11 can therefore be used as mount in an injection-molding tool in order to then be connected directly to the plastic.

In the base contact of the lampholder 1, an aperture 13 can be seen which receives a connecting wire as phase to the microchip 6 on the LED printed circuit board 5, wherein these component parts are not illustrated here. A circumferential flange 12 branching off at right angles is arranged at the upper end of the metal core and can be used as resting surface for the LED printed circuit board 5.

FIG. 4 in turn shows a perspective view of the connection comprising the core 11 and the heat sink 2. In this case, a form of illustration is selected in which the LED printed circuit board is not yet positioned onto the connection comprising the core 11 and the heat sink 2. The circumferential flange 12 can be seen at the upper end of the core 11, as well as the radially oriented cooling ribs 8 on the heat sink 2.

Finally, FIG. 5 shows an alternative design of the retrofit LED lamp in respect of the diffuser 4. Said diffuser in this design is supplemented (in comparison with FIG. 2) by a further inner remote phosphor envelope 15, which is excited by the LED emission of the LED printed circuit board 5 arranged below.

This results in the possibility of using LEDs without a phosphor content. This separation of the phosphor which is responsible for the formation of white light imparts an increased degree of efficiency to the new LEDs, i.e. a greater luminosity with a lower current consumption. In this case, the design is finished by a diffuser 4, as is also illustrated in FIG. 2.

The sleeve-shaped metal core 11 used in the design illustrated here does not have an outwardly pointing fold 11 here. Instead, a connection to the LED printed circuit board by means of riveting 16 is provided here, which connects the LED printed circuit board 6 to the metal sleeve 11.

1. A retrofit LED lamp comprising at least LED light-emitting means (7), a lampholder (1), a heat sink (2) and a diffuser envelope (4),
wherein
a high-voltage LED module (7) is used as LED light-emitting means,
voltage is supplied to said high-voltage LED module (7) via an integrated circuit (6) in the form of a microchip,
and this integrated circuit (6) of the high-voltage LED module (7) is driven directly by the mains voltage available,
wherein the heat dissipation of the high-voltage LED module (7) takes place by means of a heat sink (2) consisting of a compound plastic, which is thermally conductive via inclusions in the plastic but electrically insulating,
wherein a core (11) with a high degree of thermal conductivity in the heat sink (2) as heat-spreading medium introduces the heat output by the high-voltage LED module (7) uniformly into the heat sink (2).

2. The retrofit LED lamp as claimed in claim 1,
wherein
a metal sleeve, which is guided by the lampholder (1) continuously up to the LED printed circuit board (5), is arranged as core (11) with a high degree of thermal conductivity in the heat sink (2).

3. The retrofit LED lamp as claimed in claim 1,
wherein
the core (11) with a high degree of thermal conductivity is in the form of a sleeve-shaped continuation of the lampholder (1), with the result that an elongate sleeve-shaped core (11) is formed as a combination of the lampholder (1) with the thermally conductive core (11).

4. The retrofit LED lamp as claimed in claim 3,
wherein
the lampholder (1) is crimped onto the thermally conductive core (11) in the heat sink (2).

5. The retrofit LED lamp as claimed in claim 1,
wherein
an additional remote phosphor envelope (15) for improved light scattering is arranged between the LED printed circuit board (5) and the diffuser (4), wherein, in this arrangement, a high-voltage LED module (7) without a content of phosphor can be used.

6. The retrofit LED lamp as claimed in claim 1,
wherein
the diffuser (4) is in the form of a glass envelope coated on the inside with a remote phosphor layer.

7. The retrofit LED lamp as claimed in claim 1,
wherein
the core (11) is used as conductor for a phase (N or L).

8. The retrofit LED lamp as claimed in claim 1,
wherein
the high-voltage LED module (7) is applied directly to the metal structure of the core (11) which is deep-drawn or in the form of an extruded profile in order to economize on a printed circuit board.

9. A retrofit LED lamp comprising:
a high-voltage LED module having an integrated circuit configured to be directly driven by a mains voltage;
a lampholder;
a heat sink connected with the high-voltage LED module, comprised of a thermally conductive compound plastic, and configured to dissipate heat from the high-voltage LED module; and
a diffuser envelope, the heat sink comprising a core having a high degree of thermal conductivity and configured as a heat-spreading medium to uniformly introduce the heat output by the high-voltage LED module into the heat sink.

10. The retrofit LED lamp as claimed in claim 1, wherein the heat sink is configured to be thermally conductive via inclusions in the plastic and to remain electrically insulating.
